(19) United States
(12) Patent Application Publication
(10) Pub. No.: US 2025/0254046 A1
(43) Pub. Date: Aug. 7, 2025

(54) SECURE ONE TIME PASSWORD AUTO RETRIEVAL

(71) Applicant: WhatsApp LLC, Menlo Park, CA (US)

(72) Inventors: Ronald Anthony Kollammaparambil, Danville, CA (US); Nitin Asokan, San Jose, CA (US); Ankur Gupta, Sunnyvale, CA (US)

(21) Appl. No.: 19/038,965

(22) Filed: Jan. 28, 2025

Related U.S. Application Data
(60) Provisional application No. 63/548,919, filed on Feb. 2, 2024.

(51) Int. Cl. H04L 9/32

(52) U.S. Cl. CPC H04L 9/3228

(57) ABSTRACT

A method for authenticating a user to an application is provided. The method includes receiving, from an authentication service, a message, the message being encrypted and comprising a software identifier, a first hash identifier, and an authentication code. The method further includes decrypting the message to extract the software identifier, the first hash identifier, and the authentication code, and performing a hash operation using the software identifier as an input, to generate a second hash identifier as an output. Based on a determination that the first hash identifier matches the generated second hash identifier, the method further includes providing the authentication code to the application. A system, a memory storing instructions which, when executed by a processor cause the system to perform the above method, and the processor are also provided.

### CROSS-REFERENCE OF RELATED APPLICATION

This application claims the benefit of U.S. Provisional Application No. 63/548,919, filed on Feb. 2, 2024, and which is incorporated herein in its entirety.

### TECHNICAL FIELD

The present disclosure generally relates to authentication of a user to a software application, and more particularly to auto-retrieval of one-time password (OTP) codes.

### BACKGROUND

Users experience friction (make multiple application switches, have to memorize code quickly by looking at a notification, mistype code leading to retries, etc.) while using chat applications such as Short Messaging Service (SMS) to authenticate via OTP codes.

Businesses do not see a high conversion rate through manual OTP submission. For example, businesses see lower successful code submit rate (after successful delivery), leading to undesired drops in the conversion funnel. On chat applications, recovery use-case witnesses lower code submit success rate (as a function of code submits) when presented with a manual code entry solution versus code submits with autofill functionality. However, SMS-based OTP submission and inter-app messaging may be insecure, often being sent via plaintext rather than being end-to-end (end2end) encrypted.

As such, there is a need for a secure and seamless OTP auto-retriever solution to extract an OTP code from a user's inbox thread and submit it to a requesting third-party application.

### SUMMARY

Some embodiments of the present disclosure provide a method for authenticating a user to an application. The method includes receiving, from an authentication service, a message, the message being encrypted and including a software identifier, a first hash identifier, and an authentication code. The method further includes decrypting the message to extract the software identifier, the first hash identifier, and the authentication code. The method further includes performing a hash operation using the software identifier as an input, to generate a second hash identifier as an output. The method further includes, based on a determination that the first hash identifier matches the generated second hash identifier, providing the authentication code to the application.

Some embodiments of the present disclosure provide a non-transitory computer-readable medium storing a program for authenticating a user to an application. The program, when executed by a computer, configures the computer to receive, from an authentication service, a message, the message being encrypted and including a software identifier, a first hash identifier, and an authentication code. The program, when executed by a computer, further configures the computer to decrypt the message to extract the software identifier, the first hash identifier, and the authentication code. The program, when executed by a computer, further configures the computer to perform a hash operation using the software identifier as an input, to generate a second hash identifier as an output. The program, when executed by a computer, further configures the computer to, based on a determination that the first hash identifier matches the generated second hash identifier, provide the authentication code to the application.

Some embodiments of the present disclosure provide a system for authenticating a user to an application. The system comprises a processor and a non-transitory computer readable medium storing a set of instructions, which when executed by the processor, configure the system to receive, from an authentication service, a message, the message being encrypted and comprising a software identifier, a first hash identifier, and an authentication code. The instructions, which when executed by the processor, further configure the system to decrypt the message to extract the software identifier, the first hash identifier, and the authentication code. The instructions, which when executed by the processor, further configure the system to perform a hash operation using the software identifier as an input, to generate a second hash identifier as an output. The instructions, which when executed by the processor, further configure the system tom based on a determination that the first hash identifier matches the generated second hash identifier, provide the authentication code to the application.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 is a block diagram illustrating a network architecture for authenticating a user to an application, according to some embodiments.

FIG. 2 is a block diagram illustrating details of a system for authenticating a user to an application, according to some embodiments.

FIG. 3 is a block diagram illustrating a system used to implement secure one-time password auto-retrieval, according to some embodiments.

FIG. 4 is a flowchart illustrating a process performed by a client device, according to some embodiments.

FIG. 5 is a data flow diagram illustrating communication between applications on a client device and servers, according to some embodiments.

FIG. 6 is a data flow diagram illustrating communication between a user, a third-party application, and a messaging client, according to some embodiments.

FIG. 7 illustrates an example of code used by a third-party application to verify the identity of the messaging application, according to some embodiments.

FIG. 8 illustrates examples of user interfaces for providing a one-time password to the user, according to some embodiments.

FIG. 9A, FIG. 9B, and FIG. 9C illustrate an example workflow of a user authenticating to a third-party application by receiving a one-time password from a messaging application, according to some embodiments.

FIG. 10 illustrates an example of providing user education content to a user, according to some embodiments.

FIG. 11 is a block diagram illustrating an exemplary computer system with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

All references cited anywhere in this specification, including the Background and Detailed Description sections, are incorporated by reference as if each had been individually incorporated.

Some embodiments provide one-tap or zero-tap solutions for one-time password (OTP) auto-retrieval for a third-party application, via a secure messaging application. The auto retriever may function like an operating system-native autofill for SMS-based OTP, which is an existing model that users and/or businesses are familiar with. The auto-retrieval solution is secure, only transmitting the code securely with end-to-end encryption, and not reading any other message or accessing user data.

In some embodiments, the authentication only happens if the request and approval happens with the same device. The authentication process may require a handshake between the third-party application and the messaging client, for example, through an inter-application communication framework on the device.

In some embodiments, the solution will default to zero-tap authentication, but may have a series of fallback options to degrade gracefully as needed. For example, not all business may be ready to deploy the solution. The fallback options are as follows:
Ideal option: Zero Tap
Fallback 1: One Tap
Fallback 2: Copy Code
Fallback 3: Text-Only Template

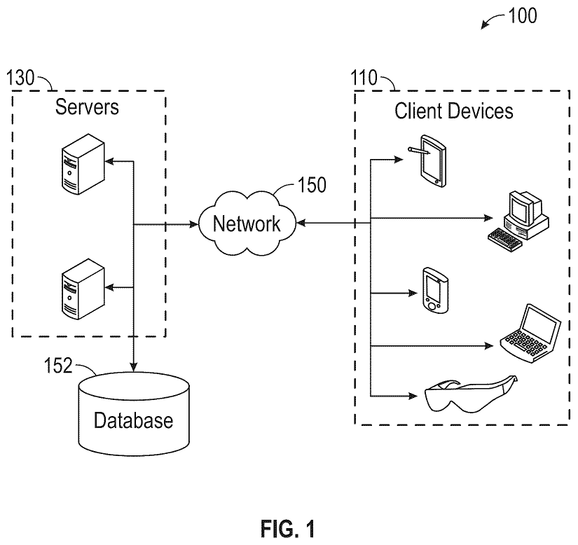

FIG. 1 illustrates a network architecture 100 for authenticating a user to an application, according to some embodiments. The network architecture 100 may include one or more client devices 110 and servers 130, communicatively coupled via a network 150 with each other and to at least one database, e.g. database 152. Database 152 may store data and files associated with the servers 130 and/or the client devices 110. In some embodiments, client devices 110 collect data, video, images, and the like, for upload to the servers 130 to store in the database 152.

The network 150 may include a wired network (e.g., fiber optics, copper wire, telephone lines, and the like) and/or a wireless network (e.g., a satellite network, a cellular network, a radiofrequency (RF) network, Wi-Fi, Bluetooth, and the like). The network 150 may further include one or more of a local area network (LAN), a wide area network (WAN), the Internet, and the like. Further, the network 150 may include, but is not limited to, any one or more of the following network topologies, including a bus network, a star network, a ring network, a mesh network, and the like.

Client devices 110 may include, but are not limited to, laptop computers, desktop computers, and mobile devices such as smart phones, tablets, televisions, wearable devices, head-mounted devices, display devices, and the like.

In some embodiments, the servers 130 may be a cloud server or a group of cloud servers. In other embodiments, some or all of the servers 130 may not be cloud-based servers (i.e., may be implemented outside of a cloud computing environment, including but not limited to an on-premises environment), or may be partially cloud-based. Some or all of the servers 130 may be part of a cloud computing server, including but not limited to rack-mounted computing devices and panels. Such panels may include but are not limited to processing boards, switchboards, routers, and other network devices. In some embodiments, the servers 130 may include the client devices 110 as well, such that they are peers.

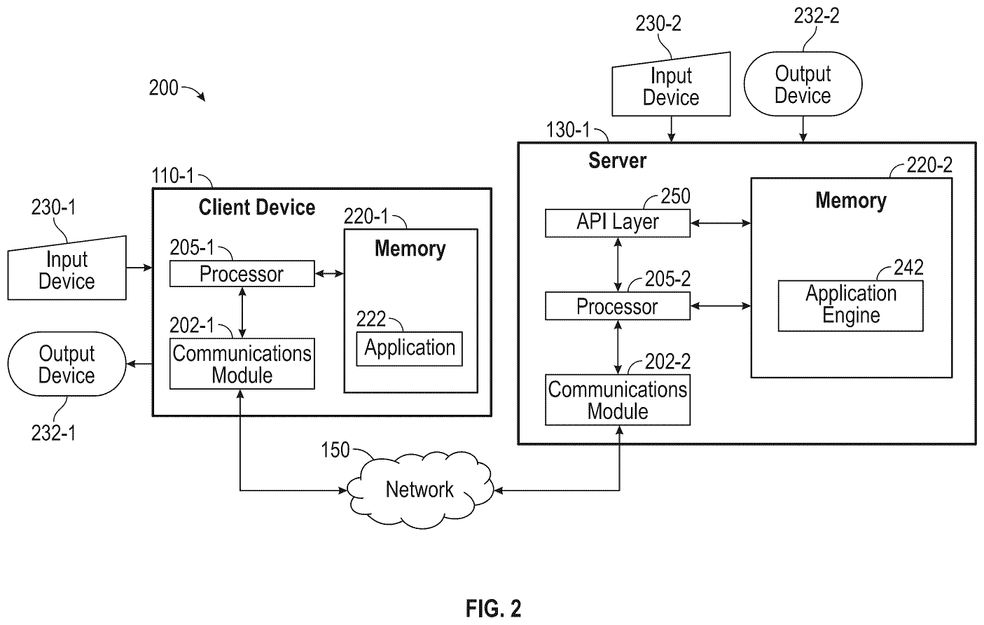

FIG. 2 is a block diagram illustrating details of a system 200 for authenticating a user to an application, according to some embodiments. Specifically, the example of FIG. 2 illustrates an exemplary client device 110-1 (of the client devices 110) and an exemplary server 130-1 (of the servers 130) in the network architecture 100 of FIG. 1.

Client device 110-1 and server 130-1 are communicatively coupled over network 150 via respective communications modules 202-1 and 202-2 (hereinafter, collectively referred to as “communications modules 202”). Communications modules 202 are configured to interface with network 150 to send and receive information, such as requests, data, messages, commands, and the like, to other devices on the network 150. Communications modules 202 can be, for example, modems or Ethernet cards, and/or may include radio hardware and software for wireless communications (e.g., via electromagnetic radiation, such as radiofrequency (RF), near field communications (NFC), Wi-Fi, and Bluetooth radio technology).

The client device 110-1 and server 130-1 also include processors 205-1 and 205-2 and memories 220-1 and 220-2, respectively. Processors 205-1 and 205-2 and memories 220-1 and 220-2 will be collectively referred to, hereinafter, as “processors 205,” and “memories 220.” Processors 205 may be configured to execute instructions stored in memories 220, to cause client device 110-1 and/or server 130-1 to perform methods and operations consistent with embodiments of the present disclosure.

The client device 110-1 and the server 130-1 may be coupled to input device 230-1 and input device 230-2, respectively (hereinafter, collectively referred to as “input devices 230”). The input devices 230 can include a mouse, a controller, a keyboard, a pointer, a stylus, a touchscreen, a microphone, voice recognition software, a joystick, a virtual joystick, a touch-screen display, and the like. In some embodiments, the input devices 230 may include cameras, microphones, sensors, and the like. In some embodiments, the sensors may include touch sensors, acoustic sensors, inertial motion units and the like.

The client device 110-1 and the server 130-1 may also be coupled to output device 232-1 and output device 232-2, respectively (hereinafter, collectively referred to as “output devices 232”). The output devices 232 may include a screen, a display (e.g., a same touchscreen display used as an input device), a speaker, an alarm, and the like. A user may interact with client device 110-1 and/or server 130-1 via the input devices 230 and the output devices 232.

Memory 220-1 may further include at least one application 222, configured to execute on client device 110-1 and couple with input device 230-1 and output device 232-1. The application 222 may be downloaded by the user from server 130-1, and/or may be hosted by server 130-1. The application 222 may include specific instructions which, when executed by processor 205-1, cause operations to be performed consistent with embodiments of the present disclosure. In some embodiments, the application 222 runs on an operating system (OS) installed in client device 110-1. In some embodiments, application 222 may run within a web browser. In some embodiments, the processor 205-1 is configured to control a graphical user interface (GUI) (e.g., spanning at least a portion of input devices 230 and output devices 232) for the user of client device 110-1 to access the server 130-1. The application 222 may also share or provide features and resources with other servers (not shown in FIG. 2) of the servers 130 in the network architecture 100 of FIG. 1.

In some embodiments, application 222 may be a messaging application, that allows a user of client device 110-1 to communicate with other users using at least text, audio, video, or any combination thereof. In some embodiments, application 222 may be a third party application. The memory 220-1 may include multiple such applications of different types and functions, which may communicate with each other directly or indirectly.

In some embodiments, memory 220-2 includes an application engine 242. The application engine 242 may be configured to perform methods and operations consistent with embodiments of the present disclosure. The application engine 242 may share or provide features and resources with the client device 110-1, including data, libraries, and/or applications retrieved with application engine 242 (e.g., application 222). The application engine 242 may also share or provide features and resources with other servers (not shown in FIG. 2) of the servers 130 in the network architecture 100 of FIG. 1.

The user may access the application engine 242 through the application 222. The application 222 may be installed in client device 110-1 by the application engine 242 and/or may execute scripts, routines, programs, applications, and the like provided by the application engine 242. In some embodiments, the application 222 may communicate with application engine 242 through an API layer 250.

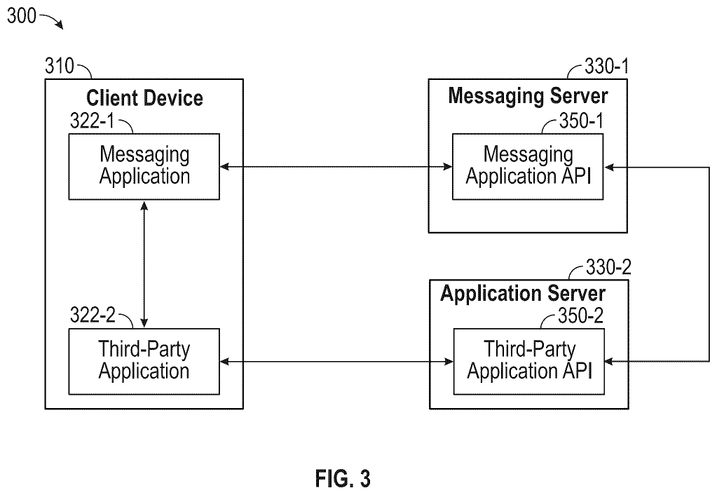

FIG. 3 is a block diagram illustrating a system 300 used to implement secure one-time password auto-retrieval, according to some embodiments. The system 300 includes a client device 310 executing a messaging application 322-1 and a third-party application 322-2, in communication with each other, for example through an inter-application messaging process or service (not shown in FIG. 3). Either or both of messaging application 322-1 and third-party application 322-2 may be an application executing within a memory of client device 310 (e.g., in the manner of application 222).

The messaging application 322-1 may be in communication with a messaging application API 315-1, executing on a messaging server 330-1. The third-party application 322-2 may be in communication with a third-party application API 315-2, executing on an application server 330-2. The third-party application API 315-2 may also communicate with the messaging server 330-1. Either or both of messaging application API 315-1 and third-party application API 315-2 may be an application executing within a memory of client device 310 (e.g., in the manner of application 222).

The client device 310 is similar to the embodiment of the client device 110-1 described above with respect to FIG. 2. Likewise, the messaging servers 330-1 and the application server 330-2 are similar to the embodiment of the server 130-1 described above with respect to FIG. 2. Wherever possible, like reference numerals have been used to refer to the same or similar components. A detailed description of these components will be omitted, and the following discussion focuses on the differences between these embodiments. Any of the various features discussed with any one of the embodiments discussed herein may also apply to and be used with any other embodiments.

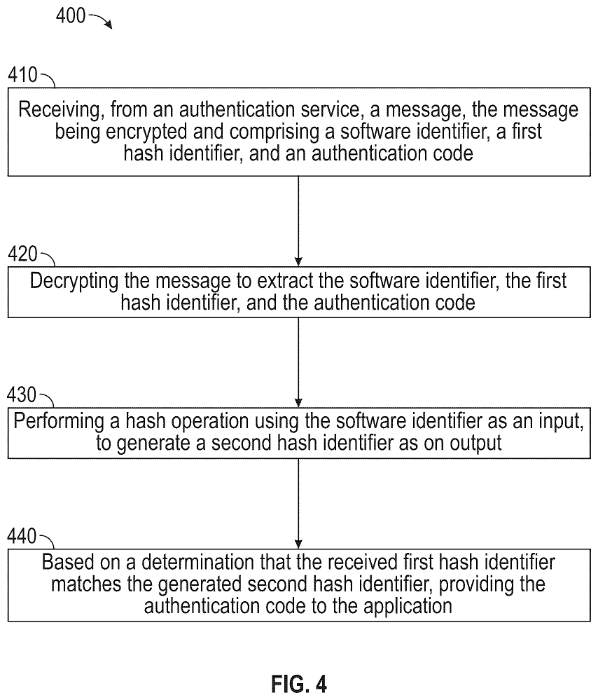

FIG. 4 is a flowchart illustrating a process 400 performed by a client device (e.g., client device 310, client device 110, etc.), according to some embodiments. In some embodiments, one or more operations in process 400 may be performed by a processor circuit (e.g., processors 212, etc.) executing instructions stored in a memory circuit (e.g., memories 220, etc.) of a system (e.g., system 200, system 300, etc.) as disclosed herein. Moreover, in some embodiments, a process consistent with this disclosure may include at least operations in process 400 performed in a different order, simultaneously, quasi-simultaneously, or overlapping in time.

At 410, the process 400 includes receiving, from an authentication service, a message, the message being encrypted and comprising a software identifier, a first hash identifier, and an authentication code. The authentication code may be, for example, a one-time password (OTP). As an example, the authentication service may be a service provided by messaging application API 315-1, executing on messaging server 330-1, and the message may be received by the messaging application 322-1.

At 420, the process 400 includes decrypting the message to extract the software identifier, the first hash identifier, and the authentication code. As a non-limiting example, the process 400 may utilize the messaging application 322-1 to perform the decryption.

At 430, the process 400 includes performing a hash operation using the software identifier as an input, to generate a second hash identifier as an output. As a non-limiting example, the process 400 may utilize the messaging application 322-1 to perform the decryption. Alternatively, the process 400 may utilize a separate security service to perform the decryption.

At 440, the process 400 provides the authentication code to the application, based on a determination that the received first hash identifier matches the generated second hash identifier. The application may then use the authentication code to authenticate the user.

For example, the application may be the third-party application 322-2, which may use the provided authentication code to make an authentication request to the third-party application API 315-2 executing on application server 330-2 and receive an authentication response from the third-party application API 315-2.

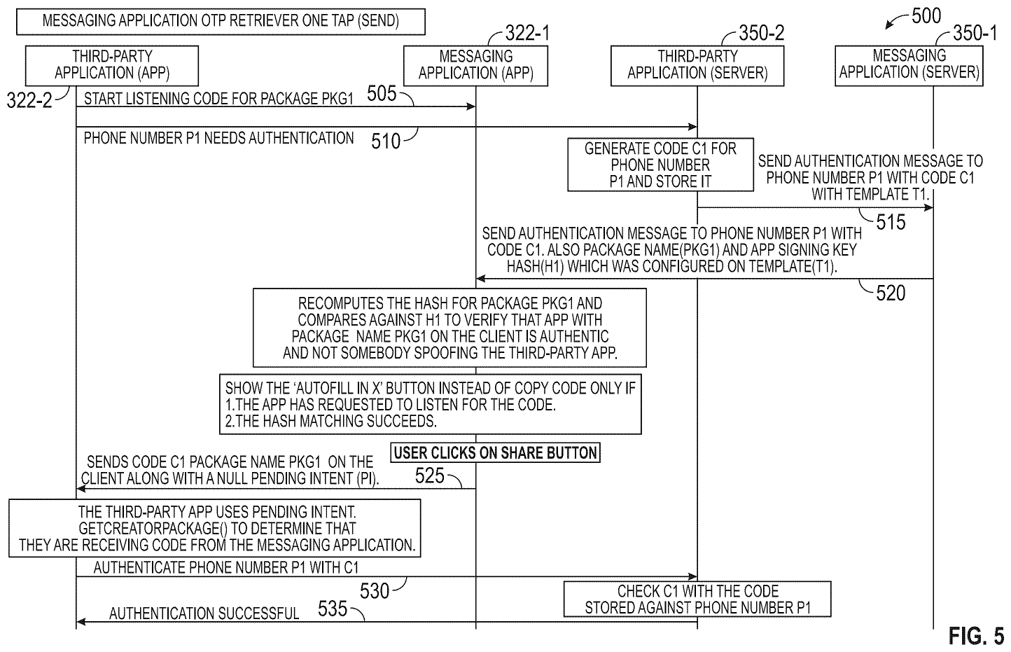

FIG. 5 is a data flow diagram 500 illustrating communication between applications on a client device and application servers, according to some embodiments. For the sake of explanation, the data flow diagram 500 is shown with reference to components of system 300, including messaging application 322-1 and third-party application 322-2 both executing on client device 310, messaging application API 315-1 executing on messaging server 330-1, and third-party application API 315-2 executing on application server 330-2, as described above with reference to FIG. 3.

The third-party application 322-2 provides a notification 505 to the messaging application 322-1 to start listening for an authentication message. The notification 505 may include an identifier (e.g., in this example, a package name Pkg1) that uniquely identifies the third-party application 322-2.

The third-party application 322-2 also provides a notification 510 to the third-party application API 315-2, to inform that an authentication request is required. The notification 510 may include identifying information associated with the client device, such as but not limited to a phone number P1 registered to the device. Upon receipt of the notification 510, the third-party application API generates and stores an authentication code C1 for phone number P1. As an example, the authentication code C1 may be a one-time password (OTP), such as a sequence of numbers and/or characters.

The third-party application API 315-2 sends a request 515 to the messaging application API 315-1, including the phone number P1, the authentication code C1, and additional information, such as a template T1. Upon receiving and validating the request 515, the messaging application API 315-1 sends an authentication message 520 to the messaging application 322-1. The authentication message 520 includes the phone number P1, the authentication code C1, and an app signing hey hash H1, which may have been configured using template T1. The authentication message 520 may also include the package name Pkg1.

In some embodiments, the authentication message 520 sent by the messaging application API 315-1 to the messaging application 322-1 is encrypted using an end-to-end encryption protocol which prevents the authentication code C1 from being sent in plaintext format over the network architecture 100. For example, the authentication message 520 may be encrypted by the messaging application API 315-1 prior to being sent to the messaging application 322-1 and is decrypted by the messaging application 322-1 upon receipt.

Upon receiving the authentication message 520, the messaging application 322-1 recomputes the hash for package Pkg1 and compares against H1 to verify that the application with the package name Pkg1 is authentic and not a malicious actor attempting to spoof the third-party application 322-2.

In some embodiments, the messaging application 322-1 is configured to provide the authentication code C1 as a one-tap scenario. In such a scenario, after verifying that the notification was received from the third-party application 322-2 to listen for the authentication message, and verifying that the recomputed hash matches H1, the messaging application 322-1 shows the authentication code C1 to the user (not shown) of the client device 310, along with a prompt to autofill the authentication code C1 in the third-party application 322-2. The prompt may include, but is not limited to, a share button, a text link, or other type of user interface control element.

If the messaging application 322-1 is not able to verify that the notification was received from the third-party application 322-2 to listen for the authentication message, and/or is unable to verify that the recomputed hash matches H1, then the messaging application 322-1 may discard the authentication code, or alternatively, may degrade to a fallback position of showing the authentication code C1 to the user with a prompt to copy the authentication code C1 if the user so desires. In this alternative, the messaging application 322-1 would not provide the autofill prompt, and the user must manually copy and paste the authentication code C1 from the messaging application 322-1 to the third-party application 322-2.

In some embodiments, the messaging application 322-1 is configured to provide the authentication code C1 as a zero-tap scenario. In such a scenario, after verifying that the notification was received from the third-party application 322-2 to listen for the authentication message, and verifying that the recomputed hash matches H1, the messaging application 322-1 automatically auto-fills the authentication code C1 to the third-party application 322-2.

Regardless of whether the messaging application 322-1 is configured to provide the authentication code C1 to the third-party application 322-2 in a one-tap or a zero-tap scenario, after successful verification, the messaging application 322-1 provides an authentication message 525 to the third-party application 322-2. The authentication message 525 includes the authentication code C1 and may also include the package name Pkg1.

After receiving the authentication code C1, the third-party application 322-2 verifies the identity of the messaging application 322-1. After verification, the third-party application 322-2 sends an authentication request 530 to the third-party application API 315-2. The authentication request 530 includes the authentication code C1 and the phone number P1.

Upon receiving the authentication request 530, the third-party application API 315-2 checks the authentication code C1 with the code previously generated against the phone number P1 and provides a response 535 to the third-party application 322-2. If the authentication codes match, then the response 535 indicates that the authentication was successful. If the codes do not match, then the response 535 indicates that the authentication was unsuccessful.

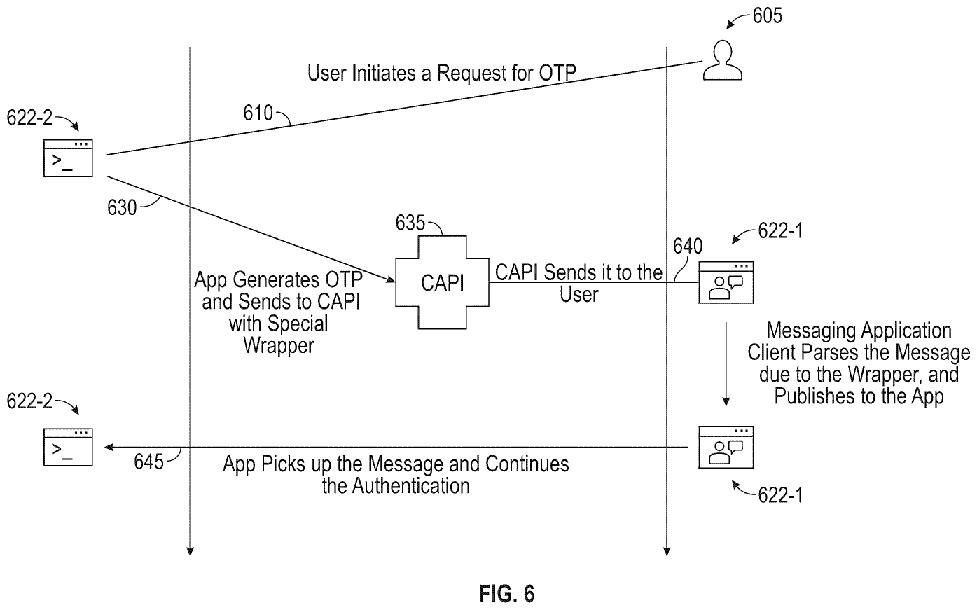

FIG. 6 is a data flow diagram 600 illustrating communication between a user 605, a messaging client 622-1, and a third-party application 622-2, according to some embodiments.

The user 605 initiates a request 610 for a one-time password (OTP) to the third-party application 622-2. The third-party application 622-2 generates an OTP (or receives an OTP from an associated API, not shown in FIG. 6), and sends a message 630 that includes the OTP to a common application programming interface (CAPI) 635. The message 630 includes a special wrapper for security and validation.

The CAPI 635 sends a message 640 that includes the OTP, to the messaging client 622-1. The messaging client 622-1 parses the message 640 due to the special wrapper and publishes the OTP using a message 645 to the third-party application 622-2. The third-party application 622-2 receives the message 645 and continues the authentication.

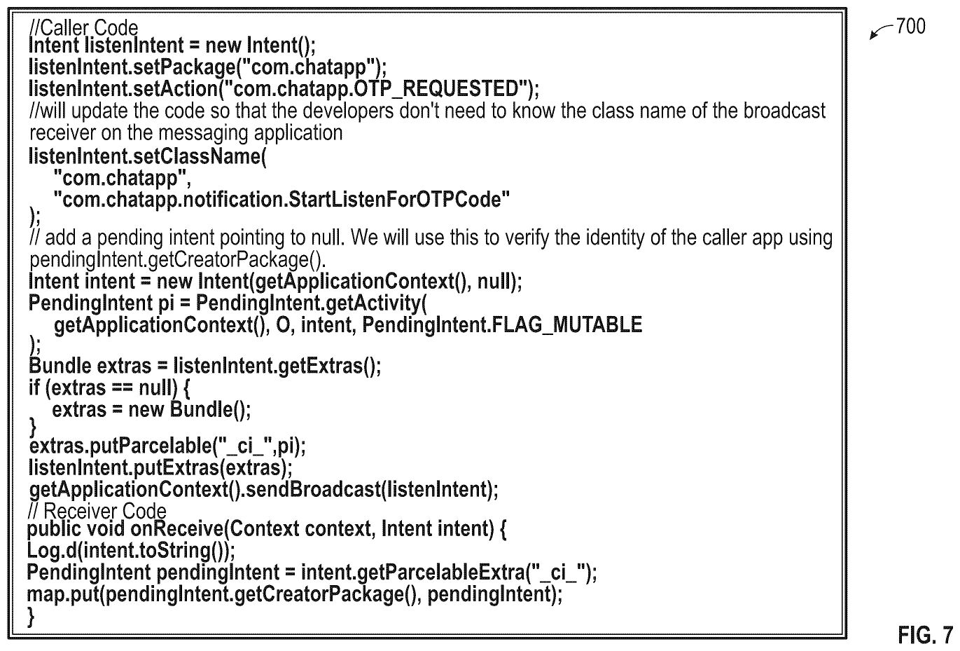

FIG. 7 illustrates an example of code 700 used by a third-party application to verify the identity of the messaging application (also referred to as the caller app), according to some embodiments. In this example, the messaging application (e.g., messaging application 322-1, or messaging client 622-1) attaches a pendingIntent to an intent. When the intent is received by the receiving app (e.g., third-party application 322-2, or third-party application 622-2), the receiving app can get the pendingIntent and use pendingIntent.getCreatorPackage( ) to determine the identity of the caller app.

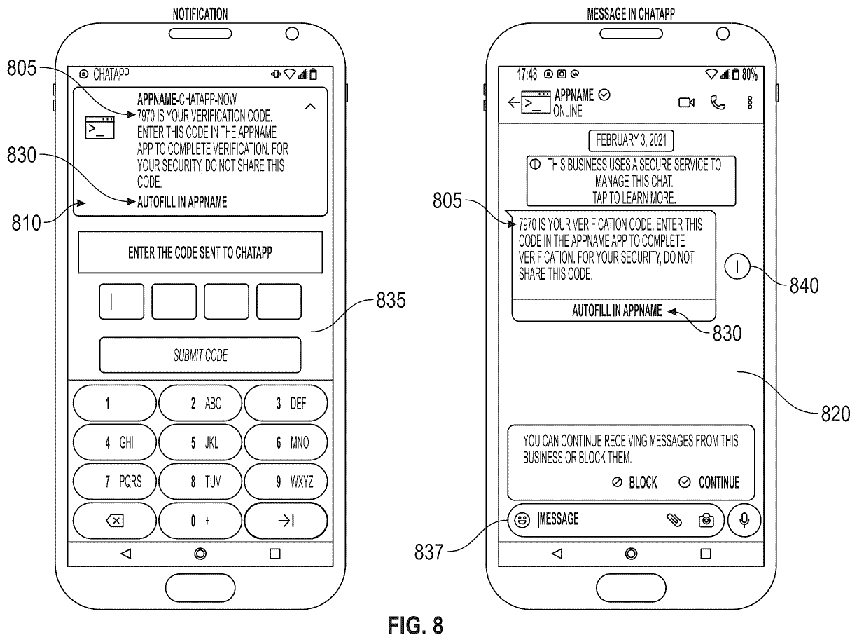

FIG. 8 illustrates examples of user interfaces for providing a one-time password 805 (in this non-limiting example, an authentication code) to the user, according to some embodiments. User interface 810 is a user interface that is external to the third-party application (e.g., third-party application 322-2, or third-party application 622-2). In this example, the user interface 810 is provided as an overlay to the third-party application. User interface 820 is an example of a native user interface that is part of the messaging application (e.g., messaging application 322-1, or messaging client 622-1), that is provided in-line as a chat conversation within the user interface of the messaging application itself. In both cases, under a one-tap scenario, an autofill prompt 830 is provided as a call-to-action (CTA) to autofill the authentication code in the third-party application. In the overlay case, the one-time password 805 may alternatively be manually entered in a dedicated region 835 of the overlaying user interface 810. In the in-line case, the one-time password 805 may be entered manually in a text entry region 837 of the messaging application user interface 820. In some embodiments, another user interface control 840 is provided to allow the user to receive user education information (e.g., privacy information, security information, etc.).

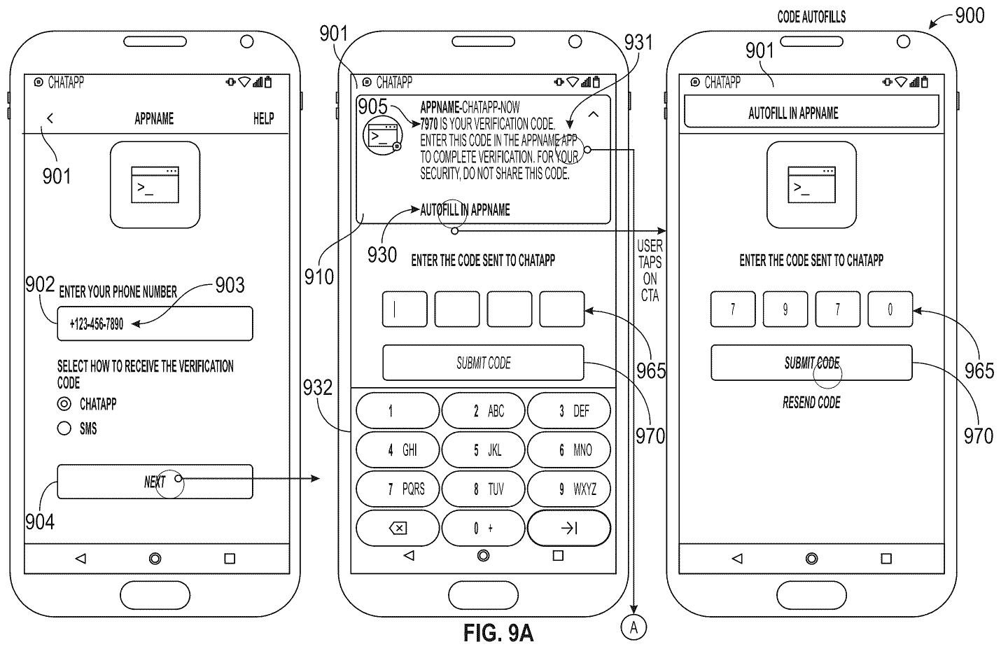

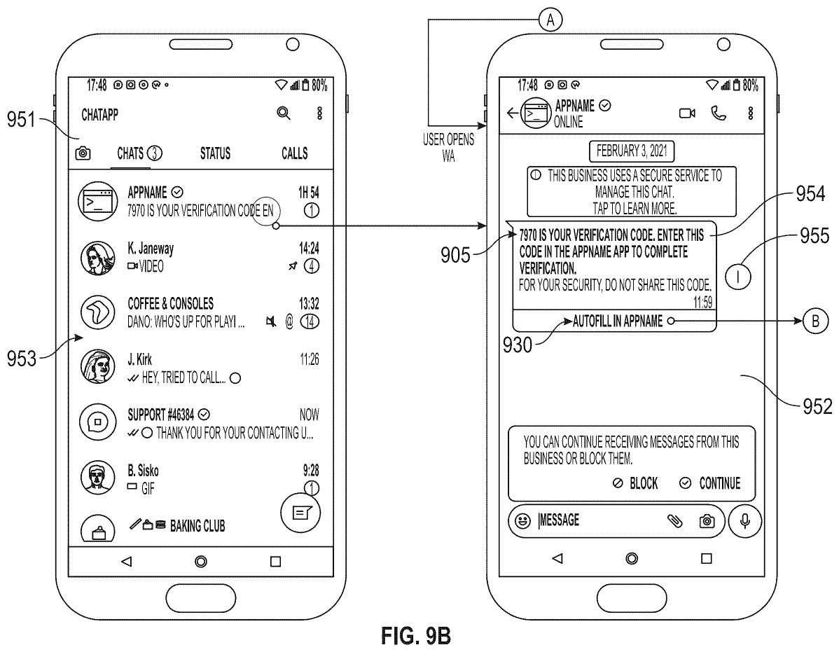

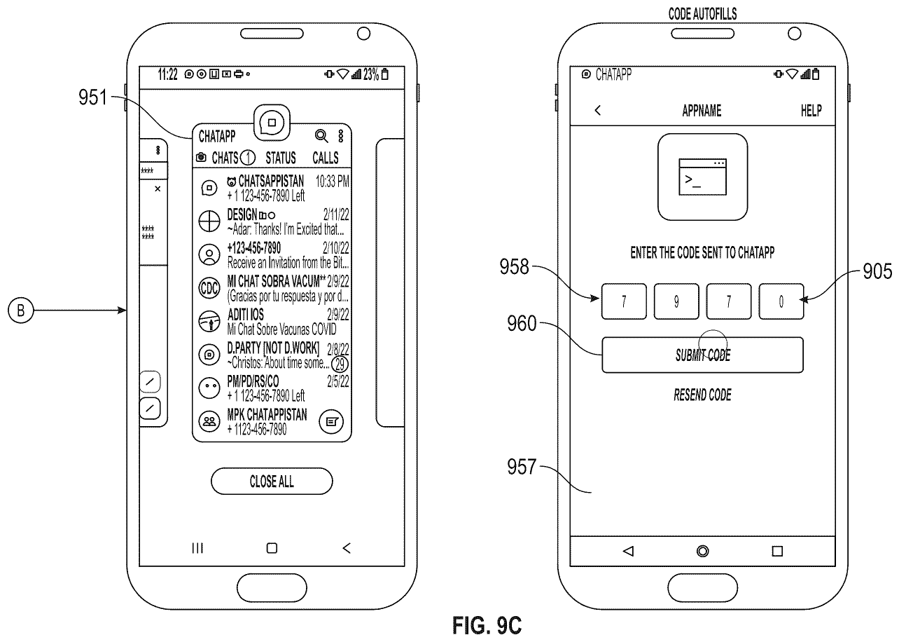

FIG. 9A, FIG. 9B, and FIG. 9C illustrate an example workflow 900 of a user authenticating to a third-party application by receiving a one-time password from a messaging application, according to some embodiments. The third-party application has a user interface 901 (shown in FIG. 9A), which has a region 902 for the user to provide contact information 903 (e.g., their phone number). The user then activates a user control 904 (e.g., a “Next” button) of the user interface 901 to submit their contact information 903 and receive the one-time password 905 as a notification from the messaging application.

In this example, the one-time password 905 is received via a user interface overlay 910, that is analogous to the overlaying user interface 810 described above with respect to FIG. 8). The user interface overlay 910 includes an autofill prompt 930 and a notification area 931. The user interface overlay 910 may also include a numeric keypad 932 if the one-time password 905 is a numeric authorization code, as in this non-limiting example. If the one-time password 905 is a combination of characters, numbers, symbols, and the like, then a suitable alphanumeric keyboard may be shown instead of the numeric keypad 932.

In this non-limiting example, the user may (A) select the notification area 931 from the user interface overlay 910, or (B) select the autofill prompt 930 from the user interface overlay 910. In some embodiments, activating the user control 904 of the user interface 901 to submit their contact information 903 automatically submits the one-time password, without needing to interact with the user interface overlay 910.

If the user selects, from the user interface overlay 910, the notification area 931, the third-party application is replaced by the messaging application (shown in FIG. 9B). The one-time password 905 may be provided to the user within a user interface 951 of the messaging application, e.g., via a separate chat conversation 952. In the example of FIG. 9B, selecting the notification area 931 takes the user directly to the chat conversation 952. However, the user may also manually select the chat conversation 952 from a list of conversations 953 within the user interface 951 of the messaging application.

The chat conversation 952 may be displayed to the user analogous to the user interface 820 of the messaging application described above with respect to FIG. 8. The one-time password 905 is provided in chat conversation 952 as a received chat message 954 from the third-party associated with the third-party application. The autofill prompt 930 is further provided in chat conversation 952 to the user. Another user interface control 955 may also be provided to allow the user to receive user education information (e.g., privacy information, security information, etc.).

From the chat conversation 952, when the user selects the autofill prompt 930 (see FIG. 9B), the messaging application may be automatically replaced in some embodiments by the third-party application (shown in FIG. 9C). In other embodiments, the user may manually switch from the messaging application to the third-party application. The third-party application has a user interface 957, and the one-time password 905 may be automatically entered in a region 958 thereof. The one-time password 905 may then be submitted for authentication, e.g. using a user interface control of the user interface 957, such as submit button 960. In some embodiments, the one-time password 905 may be submitted automatically after selection of the autofill prompt 930 from the chat conversation 952 (see FIG. 9B), without needing to interact with the user interface 957.

If the user selects, from the user interface overlay 910, the autofill prompt 930 (see FIG. 9A), the one-time password 905 may be automatically entered in a receiving region 965 of the user interface 901. The one-time password 905 may then be submitted for authentication, e.g. using a user interface control of the user interface 901, such as submit button 970.

Alternatively, the user may manually enter the one-time password 905 in the receiving region 965 of the user interface 901 (shown in FIG. 9A) using the numeric keypad 932. The one-time password 905 may then be submitted for authentication, e.g. using a user interface control of the user interface 901, such as submit button 970.

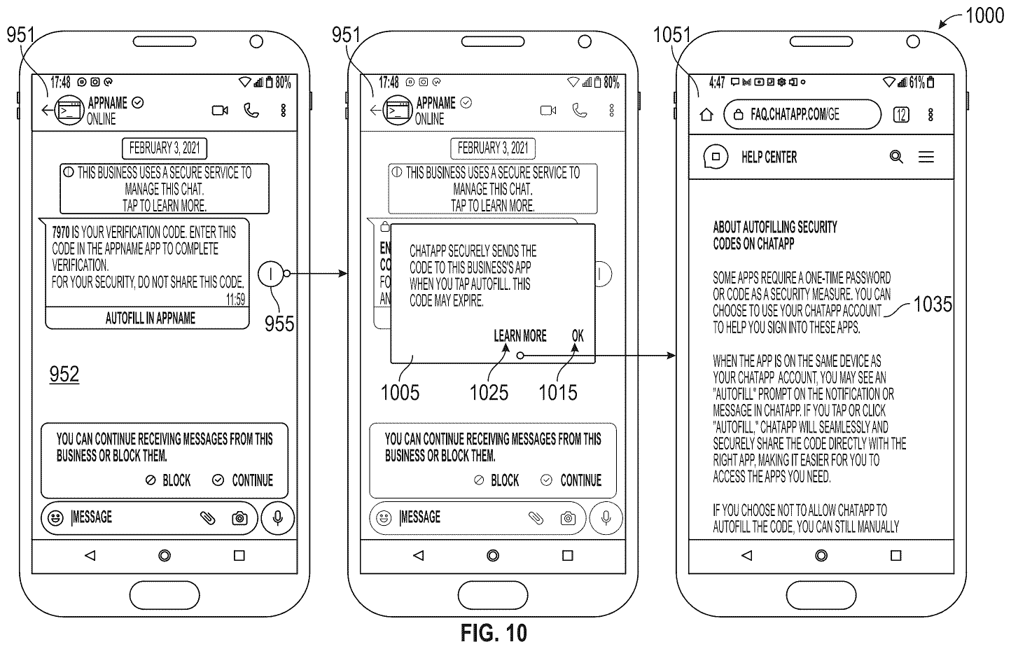

FIG. 10 illustrates an example of providing user education content to a user, according to some embodiments. Continuing the example of FIG. 9B, if the user selects user interface control 955 from the chat conversation 952, an informational dialog 1005 may be presented as an overlay of user interface 951 of the messaging application. The informational dialog 1005 may include a user control 1015 to dismiss the overlay (e.g., “OK”) and may include another user control 1025 to provide more details on the authentication process to the user. When the user selects user control 1025, additional information 1035 may be provided to the user. In the example of FIG. 10, the additional information 1035 is provided from a website that is opened in a browser application 1051, automatically after the user selects user control 1025.

Table 1 summarizes behavior during edge case scenarios, according to some embodiments.

TABLE 1

| Scenario | Expectation |
|---|---|
| Users messaging client or OS is a version that | The user will see the traditional copy code |
| does not support auto retriever | button and the auto retriever functionality will |
| | have no effect on users with lower client of |
| | OS versions |
| Users messaging client or OS is a version that | Clicking on copy code button will open |
| does not support auto retriever or copy code | fallback website |
| Third-party application has not initiated the | The user will see the traditional copy code |
| handshake before the OTP code was sent | button and the auto retriever functionality will |
| | have no effect on the user |
| Autofill no longer works when third-party | Disable the call to action 10 minutes after the |
| application is no longer expecting code | OTP message is received |
| User already submitted code | |
| User waits too long to submit code | |
| User comes back long time later and | |
| sees old unread chat | |
| Forwarded OTP messages | Autofill messages will not be forward-able to |
| | reduce chances of account takeovers via |
| | phishing |
| Multi Device Support | Handshake will be used to show copy code |
| | instead of AutoFill code on any device where |
| | the request is not originating from |
| Info icon needs to show a message for a non- | OTP education message dialog will be |
| OTP scenario | deprioritized and not shown |

Table 2 summarizes various security and privacy risks, and mitigation of these risks, according to some embodiments.

TABLE 2

| Theme | Scenario / Risk | Mitigation |
|---|---|---|
| Security | Providing a secure auto retriever | Same device authentication only: |
| | solution across multi device has | Initially, the auto-retriever solution |
| | added security challenges | for authentication may only be |
| | | supported when the requesting third- |
| | | party application and the messaging |
| | | client are present on the same device |
| | | (similar to SMS) |
| Security | Other (irrelevant) third-party | Only verified and whitelisted apps |
| | applications may try to get access to | may be able to use the auto-retriever |
| | the OTP code sent to the user | functionality and the messaging |
| | | application will verify the third-party |
| | | application's code signing certificate |
| | | before sharing the OTP code |
| Security | Ensure that the messaging application | Handshake: The third-party |
| | passes the OTP code to the third-party | application will initiate a handshake |
| | application only at the time of | signal informing the messaging |
| | authentication | application that it's ready to accept |
| | | the code. The extracted OTP code |
| | | will be shared only to the third-party |
| | | application after the handshake signal |
| | | is received |
| Privacy | Accidental exposure of other non- | OTP code is a structured field: OTP |
| | OTP user data to the third-party | code will be a structured field and |
| | application | hence it will only be possible to |
| | | access and transmit back the specific |
| | | data that was generated by that |
| | | specific third-party application |
| Privacy | User / public-relation concerns about | Provide passive and persistent in- |
| | E2EE, data sharing, privacy, security, | product user education and |
| | etc | information, as well as have reactive |
| | | communications |

Table 3 summarizes a logging schema, according to some embodiments.

TABLE 3

| Parameter | Description |
|---|---|
| event_type (enum) | impression |
| | click (one tap) |
| | otp_code_sent |
| | otp_requested |
| event_source (enum) | notification_cta |
| | notification_body |
| | chat_cta |
| | other |
| session_id | session_id to correlate different events |
| | related to a particular otp session. |
| | session_id would be created on client side |
| template_id | template_id for the otp template |
| business_phone_number | business phone number |
| third_party_package_name | third-party package name |
| ps_id | private stats id for the user. |
| product_type | one_tap / zero_tap |
| timestamp | timestamp |
| metadata | copy_code_fallback_hash_mismatch |
| | hash received in otp template |
| | hash computed on the client |
| | cta_is_fallback |
| | reason (Hash mismatch / No start |
| | listen received) |
| | cta type (autofill / copy code) |
| | third-party package name (for event type |
| | signal_start_listen_for_code_received) |

Some embodiments use templates for providing OTPs. Information that is provided while creating an OTP template includes, but is not limited to, package name, call-to-action (CTA) display name, a flag to indicate whether zero-tap is enabled, and a hash of the application signing key.

The OTP copy code Uniform Resource Locator (URL) is typically provided in the following format:
https://{domain name}/otp/copy/{code}

For example, for domain MessagingAppName.com and OTP code 123456, the URL would be https://www.MessagingAppName.com/otp/copy/123456. This only works for copy code.

When one-tap or zero tap authentication is provided, the business or user must specify more information like package name, CTA display name, and hash of the app signing key. In some embodiments, the OTP URL use the following format:
https://{domain name}/otp/copy?{otp_metadata}&code={code}

The field otp_metadata may be provided by the business at the time of template creation. This field would be optional if the user only wants to use copy code functionality rather than one-tap or zero-tap. The code will be provided by the business dynamically at the time of message sent. If the business only wants copy code functionality, they may use the following format:
https://{domain name}/otp/copy?code=123456

In some embodiments, if the business wants to use OTP one-tap and/or zero-tap retriever functionality, they may use the following format:
https://{domain name}/otp/copy?package_name=com.example.myapplication&cta_display_name=SampleApp&hash_of_app_signing_key=1245asda5&code=123456

Some embodiments require the third-party app to implement both broadcast receiver and activity to listen on the OTP intent (e.g., com.MessagingAppName.OTP_RETRIEVED). The activity may be launched in one tap and the code sent to the broadcast receiver in zero tap. Some of these scenarios are summarized in Tables 4 and 5, below.

For one tap, it may not be feasible to launch the third-party application from notification CTA when both the messaging application and the third-party application is in the background using a broadcast receiver. Therefore, in some embodiments, it is preferable to launch the activity from the notification CTA in one tap. See [1] in Table 4.

For zero tap, it may not be feasible to share the code with the third-party application if the messaging application is in the background using an activity. Therefore, in some embodiments, it is preferable to use a broadcast receiver in zero tap. See [2] in Table 5.

In some embodiments, one-tap launches the third-party application using the CTA, and hence using an activity.

In some embodiments, zero-tap shares the authentication code in the background because there is no CTA. If the third-party application is already in the foreground, the authentication code will show on the app. Otherwise, the user will see the code when they go back to the third-party application. These scenarios are illustrated in FIGS. 9A-9C.

In some embodiments, launching an activity may interrupt user activity. As an example, if the user was trying to login to the third-party application, requested the code on the messaging application, and somehow logged into the third-party application through other means and is now engaged in an activity on the third-party application, the code may arrive on the messaging application and be shared on the third-party application, causing the user to go back to the login screen of the third-party application and interrupting the activity.

A solution in some embodiments is that the user may receive the code in an entirely separate activity (e.g ReceiveOTPCodeActivity). The user can call finish on that activity immediately after receiving the code and that will bring the saved state of the application into the foreground. Alternatively, the user can explicitly launch the login activity (activity which will complete the user authentication) after receiving the code. It will be up to the businesses to decide how to handle the receiving of the OTP code.

To ensure that the authentication code is sent to the correct third-party application, the following OTP flow may be used in some embodiments:
(1) The business (e.g., the owner of the third-party application) requests for the code from the messaging application on the client. This will make sure that the code is only shared with the application when they are already listening for it. This also solves the multi device case, because if a user has the messaging application on multiple devices, the code will be shared to the third-party application on a device if it explicitly requests for the code on that device only.
(2) The business provides their package name and hash of the app signing key in an OTP template. The messaging client checks if the hash of the app signing key in the template message matches the one on the client (e.g., queried through operating system APIs). This will make sure that the code is not shared with any other application that is spoofing the this party application on the client by using the same package name.

When the messaging client shares the code with the third-party application, it will attach a pending intent to the intent that shares the code. For example, the third-party application can use pendingIntent.getCreatorPackage( ) (see FIG. 7) to verify that they are receiving the code from the messaging application only and not any other malicious application on the client.

Table 4 summarizes the feasibility of sharing code with a third-party application, using one-tap, according to some embodiments.

TABLE 4

| | | Calling broadcast | |
|---|---|---|---|
| | | receiver to receive | |
| | | code and launch the | |
| | Calling broadcast | activity if third-party | Launching activity |
| | receiver to receive | application is in | directly to receive |
| | code | background | the code |
| From notification | YES | NO [1] | YES |
| CTA | | | |
| (MessagingAppName | | | |
| in background, third- | | | |
| party application in | | | |
| background) | | | |
| From notification | YES | YES | YES |
| CTA | | | |
| (MessagingAppName | | | |
| in foreground) | | | |
| From notification | YES | YES [third-party | YES [third-party |
| CTA (third-party | | application already | application already |
| application in | | in foreground] | in foreground] |
| foreground) | | | |
| From chat CTA | YES | YES | YES |

Table 5 summarizes the feasibility of sharing code with a third-party application, using zero-tap, according to some embodiments.

TABLE 5

| | | Calling broadcast | |
|---|---|---|---|
| | | receiver to receive | |
| | | code and launch the | |
| | Calling broadcast | activity if third-party | Launching activity |
| | receiver to receive | application is in | directly to receive the |
| | code | background | code |
| MessagingAppName | YES | NO | NO [2] |
| in background, Third- | | | |
| party app in | | | |
| background | | | |
| MessagingAppName | YES | YES [third-party | YES [third-party |
| in background, Third- | | application already in | application already in |
| party app in | | foreground] | foreground] |
| foreground | | | |
| MessagingAppName | YES | YES | YES |
| in foreground | | | |

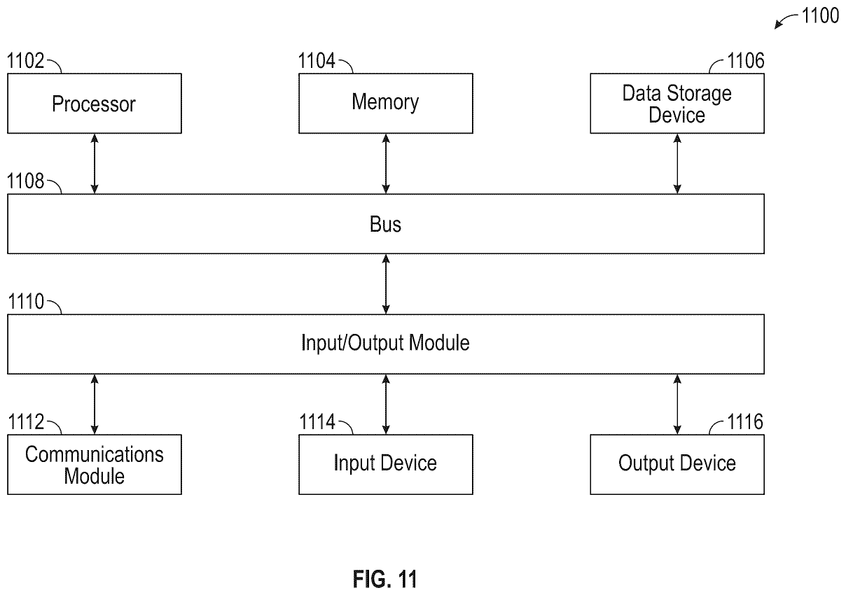

FIG. 11 is a block diagram illustrating an exemplary computer system 1100 with which aspects of the subject technology can be implemented. In certain aspects, the computer system 1100 may be implemented using hardware or a combination of software and hardware, either in a dedicated server, integrated into another entity, or distributed across multiple entities. As a non-limiting example, the computer system 1100 may be one or more of the servers 130 and/or the client devices 110.

Computer system 1100 includes a bus 1108 or other communication mechanism for communicating information, and a processor 1102 coupled with bus 1108 for processing information. By way of example, the computer system 1100 may be implemented with one or more processors 1102. Processor 1102 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1100 can include, in addition to hardware, code that creates an execution environment for the computer program in question, e.g., code that constitutes processor firmware, a protocol stack, a database management system, an operating system, or a combination of one or more of them stored in an included memory 1104, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 1108 for storing information and instructions to be executed by processor 1102. The processor 1102 and the memory 1104 can be supplemented by, or incorporated in, special purpose logic circuitry.

The instructions may be stored in the memory 1104 and implemented in one or more computer program products, i.e., one or more modules of computer program instructions encoded on a computer-readable medium for execution by, or to control the operation of, the computer system 1100, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, Wirth languages, and xml-based languages. Memory 1104 may also be used for storing temporary variable or other intermediate information during execution of instructions to be executed by processor 1102.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 1100 further includes a data storage 1106 such as a magnetic disk or optical disk, coupled to bus 1108 for storing information and instructions. Computer system 1100 may be coupled via input/output module 1110 to various devices. The input/output module 1110 can be any input/output module. Exemplary input/output modules 1110 include data ports such as USB ports. The input/output module 1110 is configured to connect to a communications module 1112. Exemplary communications modules 1112 include networking interface cards, such as Ethernet cards and modems. In certain aspects, the input/output module 1110 is configured to connect to a plurality of devices, such as an input device 1114 and/or an output device 1116. Exemplary input devices 1114 include a keyboard and a pointing device, e.g., a mouse or a trackball, by which a user can provide input to the computer system 1100. Other kinds of input devices 1114 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 1116 include display devices such as an LCD (liquid crystal display) monitor, for displaying information to the user.

According to one aspect of the present disclosure, the above-described systems can be implemented using a computer system 1100 in response to processor 1102 executing one or more sequences of one or more instructions contained in memory 1104. Such instructions may be read into memory 1104 from another machine-readable medium, such as data storage 1106. Execution of the sequences of instructions contained in the memory 1104 causes processor 1102 to perform the process steps described herein. One or more processors in a multi-processing arrangement may also be employed to execute the sequences of instructions contained in memory 1104. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 1100 can include clients and servers. A client and server are generally remote from each other and typically interact through a communication network. The relationship of client and server arises by virtue of computer programs running on the respective computers and having a client-server relationship to each other. Computer system 1100 can be, for example, and without limitation, a desktop computer, laptop computer, or tablet computer. Computer system 1100 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 1102 for execution. Such a medium may take many forms, including, but not limited to, non-volatile media, volatile media, and transmission media. Non-volatile media include, for example, optical or magnetic disks, such as data storage 1106. Volatile media include dynamic memory, such as memory 1104. Transmission media include coaxial cables, copper wire, and fiber optics, including the wires that comprise bus 1108. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the computing system 1100 reads application data and provides an application, information may be read from the application data and stored in a memory device, such as the memory 1104. Additionally, data from the memory 1104 servers accessed via a network, the bus 1108, or the data storage 1106 may be read and loaded into the memory 1104. Although data is described as being found in the memory 1104, it will be understood that data does not have to be stored in the memory 1104 and may be stored in other memory accessible to the processor 1102 or distributed among several media, such as the data storage 1106.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In some embodiments, the computer-readable media is non-transitory computer-readable media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

The claims are not intended to be limited to the aspects described herein but are to be accorded the full scope consistent with the language of the claims and to encompass all legal equivalents. Notwithstanding, none of the claims are intended to embrace subject matter that fails to satisfy the requirement of 35 U.S.C. § 101, 102, or 103, nor should they be interpreted in such a way.

1. A method for authenticating a user to an application, comprising:
receiving, from an authentication service, a message, the message being encrypted and comprising a software identifier, a first hash identifier, and an authentication code;
decrypting the message to extract the software identifier, the first hash identifier, and the authentication code;
performing a hash operation using the software identifier as an input, to generate a second hash identifier as an output; and
based on a determination that the first hash identifier matches the generated second hash identifier, providing the authentication code to the application.

2. The method of claim 1, wherein the software identifier is a first software identifier, the message is a first message, the determination is a first determination, and the method further comprises:
receiving, from the application, a second message comprising a second software identifier that corresponds to the application; and
making a second determination that the first software identifier matches the second software identifier,
wherein generating the second hash identifier is based on the second determination.

3. The method of claim 2, further comprising:
receiving, from the authentication service, a third message, the third message comprising a third software identifier;
making a third determination that the first software identifier does not match the third software identifier; and
based on the third determination, discarding the third message.

4. The method of claim 1, further comprising:
providing to the user, on a user interface, a prompt to provide the authentication code to the application; and
receiving from the user, through the user interface, a user selection of the prompt,
wherein providing the authentication code to the application is in response to receiving the user selection of the prompt.

5. The method of claim 4, wherein the prompt is a first prompt, the user selection is a first user selection, and the method further comprises:
providing to the user, through the user interface, a second prompt to provide user education content;
receiving from the user, through the user interface, a second user selection of the second prompt; and
in response to the second user selection, providing to the user, through the user interface, the user education content,
wherein the second prompt is provided to the user prior to providing the first prompt or simultaneously with the first prompt.

6. The method of claim 4, wherein the user interface is a first user interface external to the application, and the method further comprises:
providing to the user, through the first user interface, the authentication code; and
receiving from the user, through the user interface, a copy command to store the authentication code,
wherein the application comprises a second user interface, and providing the authentication code to the application comprises receiving from the user, through the second user interface, a paste command of the authentication code to the application.

7. The method of claim 6, wherein the first user interface is provided to the user as an overlay to the application.

8. A non-transitory computer-readable medium storing a program for authenticating a user to an application, which when executed by a computer, configures the computer to:
receive, from an authentication service, a message, the message being encrypted and comprising a software identifier, a first hash identifier, and an authentication code;
decrypt the message to extract the software identifier, the first hash identifier, and the authentication code;
perform a hash operation using the software identifier as an input, to generate a second hash identifier as an output; and
based on a determination that the first hash identifier matches the generated second hash identifier, provide the authentication code to the application.

9. The non-transitory computer-readable medium of claim 8, wherein the software identifier is a first software identifier, the message is a first message, the determination is a first determination, and the program, when executed by the computer, further configures the computer to:
receive, from the application, a second message comprising a second software identifier that corresponds to the application; and
make a second determination that the first software identifier matches the second software identifier,
wherein generating the second hash identifier is based on the second determination.

10. The non-transitory computer-readable medium of claim 9, wherein the program, when executed by the computer, further configures the computer to:
receive, from the authentication service, a third message, the third message comprising a third software identifier;
make a third determination that the first software identifier does not match the third software identifier; and
based on the third determination, discard the third message.

11. The non-transitory computer-readable medium of claim 8, wherein the program, when executed by the computer, further configures the computer to:
provide to the user, on a user interface, a prompt to provide the authentication code to the application; and
receive from the user, through the user interface, a user selection of the prompt,
wherein providing the authentication code to the application is in response to receiving the user selection of the prompt.

12. The non-transitory computer-readable medium of claim 11, wherein the prompt is a first prompt, the user selection is a first user selection, and the program, when executed by the computer, further configures the computer to:
provide to the user, through the user interface, a second prompt to provide user education content;
receive from the user, through the user interface, a second user selection of the second prompt; and
in response to receiving the second user selection, provide to the user, through the user interface, the user education content,
wherein the second prompt is provided to the user prior to providing the first prompt or simultaneously with the first prompt.

13. The non-transitory computer-readable medium of claim 11, wherein the user interface is a first user interface external to the application, and the program, when executed by the computer, further configures the computer to:
provide to the user, through the first user interface, the authentication code; and
receive from the user, through the user interface, a copy command to store the authentication code,
wherein the application comprises a second user interface, and providing the authentication code to the application comprises receiving from the user, through the second user interface, a paste command of the authentication code to the application.

14. The non-transitory computer-readable medium of claim 13, wherein the first user interface is provided to the user as an overlay to the application.

15. A system for authenticating a user to an application, comprising:
a processor; and
a non-transitory computer readable medium storing a set of instructions, which when executed by the processor, configure the system to:
receive, from an authentication service, a message, the message being encrypted and comprising a software identifier, a first hash identifier, and an authentication code;
decrypt the message to extract the software identifier, the first hash identifier, and the authentication code;
perform a hash operation using the software identifier as an input, to generate a second hash identifier as an output; and
based on a determination that the first hash identifier matches the generated second hash identifier, provide the authentication code to the application.

16. The system of claim 15, wherein the software identifier is a first software identifier, the message is a first message, the determination is a first determination, and the instructions, when executed by the processor, further configure the system to:
receive, from the application, a second message comprising a second software identifier that corresponds to the application; and
make a second determination that the first software identifier matches the second software identifier,
wherein generating the second hash identifier is based on the second determination.

17. The system of claim 16, wherein the instructions, when executed by the processor, further configure the system to:
receive, from the authentication service, a third message, the third message comprising a third software identifier;
make a third determination that the first software identifier does not match the third software identifier; and
based on the third determination, discard the third message.

18. The system of claim 15, wherein the instructions, when executed by the processor, further configure the system to:
provide to the user, on a user interface, a prompt to provide the authentication code to the application; and
receive from the user, through the user interface, a user selection of the prompt,
wherein providing the authentication code to the application is in response to receiving the user selection of the prompt.

19. The system of claim 18, wherein the prompt is a first prompt, the user selection is a first user selection, and the instructions, when executed by the processor, further configure the system to:
provide to the user, through the user interface, a second prompt to provide user education content;
receive from the user, through the user interface, a second user selection of the second prompt; and
in response to receiving the second user selection, provide to the user, through the user interface, the user education content,
wherein the second prompt is provided to the user prior to providing the first prompt or simultaneously with the first prompt.

20. The system of claim 18, wherein the user interface is a first user interface external to the application, and the instructions, when executed by the processor, further configure the system to:
provide to the user, through the first user interface, the authentication code; and
receive from the user, through the user interface, a copy command to store the authentication code,
wherein the application comprises a second user interface, and providing the authentication code to the application comprises receiving from the user, through the second user interface, a paste command of the authentication code to the application.
